(19) United States
(12) Patent Application Publication
(10) Pub. No.: US 2006/0251977 A1
(43) Pub. Date: Nov. 9, 2006

(54) Electrophotographic developing agent and electrophotographic imaging apparatus employing the same

(75) Inventor: Jun-ho Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/396,587

(22) Filed: Apr. 4, 2006

(30) Foreign Application Priority Data
May 4, 2005 (KR) 10-2005-0037423

(51) Int. Cl. G03G 9/08

(52) U.S. Cl. 430/108.3; 430/108.4; 430/108.1

(57) ABSTRACT

An electrophotographic developing agent including toner particles containing a binder resin, a colorant, a charge control agent and a release agent, and an external additive to be added to the surface of the toner particles, wherein the charge control agent is a light metal complex compound, the release agent is a solid fatty acid ester based material, and the amount of the release agent is 1.5 to 4.0% by weight based on total weight of the toner particles. An electrophotographic image forming apparatus applying the electrophotographic developing agent is also provided. The developing agent can distribute stable charges over long term by using a light metal complex as a charge control agent and 1.5 to 4.0% by weight of a solid fatty acid ester-based material as a release agent in preparing a toner. Further, according to the developing agent, excellent toner fusing property and developing property can be maintained. Therefore, toner durability can be enhanced due to control of contamination and scattering, and enhancement of developing efficiency, and thus high quality of images can be obtained.

### CROSS-REFERENCE TO RELATED PATENT APPLICATION

This application claims the benefit of Korean Patent Application No. 10-2005-0037423, filed on May 4, 2005, in the Korean Intellectual Property Office, the disclosure of which is incorporated herein by reference in its entirety.

### BACKGROUND OF THE INVENTION

1. Field of the Invention

The present invention relates to an electrophotographic developing agent. More particularly, the invention is directed to an electrophotographic developing agent comprising a charge control agent and a release agent in a developing apparatus of an electrophotographic image-processing machine.

2. Description of the Related Art

Currently, many electrophotographic image processing machines are in use such as a laser printer, a facsimile and a copying machine, etc.. They form latent image on a photoreceptor using a laser, migrate a toner onto the latent image on the photoreceptor using an electric potential difference, and transfer the latent image to a printing medium such as a paper to give desired image.

FIG. 1 illustrates an example of non-contact developing type image forming apparatus, of which the operating mechanism is described below. The present invention can also be applied to contact developing type.

A non-magnetic one-component developing agent is fed on a developing roller 5 by a feeding roller 6 made of an elastic member such as a polyurethane foam or a sponge, etc. The developing agent 8 fed on the developing roller 5 arrives at contacting part of a developing agent regulation blade 7 and the developing roller 5 through rotation of the developing roller 5. The developing agent regulation blade 7 is made of an elastic member such as metal or a rubber, etc. When the developing agent is passed through the contacting part of a developing agent regulation blade 7 and the developing roller 5, a layer of the developing agent 8 is controlled in a uniform layer to form a thin layer and to charge the developing agent sufficiently. Thin layered developing agent 8 is migrated, by the developing roller 5, to a developing area where the developing agent 8 is developed on a latent image of a photoreceptor 1 supporting the latent image.

The developing roller 5 faces the photoreceptor 1, without contacting the photoreceptor. The developing roller 5 rotates in a counterclockwise direction, and the photoreceptor 1 rotates in a clockwise direction. The developing agent 8 supplied to the developing area is developed on the latent image of the photoreceptor 1 by electric power generated by an electric potential difference between the DC overlapped AC voltage applied to the developing roller 5 and the electric potential of the latent image on the photoreceptor 1.

The developing agent 8 developed on the photoreceptor 1 arrives at a position of a transferring means 9 following the rotating direction of the photoreceptor 1. The developing agent developed on the photoreceptor 1 is transferred onto a printing paper 13, which is passed through the developing area by the transferring means 9 on which high voltage having counter polarity to the developing agent 8 is applied through corona discharge or in roller form, to transfer the image.

The image transferred to the printing paper is passed through a fusing apparatus (not shown) at high temperature and high pressure, where the developing agent is melted on the printing paper thereby fusing the image. Meanwhile, the undeveloped developing agent remaining on the developing roller 5 is recovered by the feeding roller 6 in contact with the developing roller 5. These procedures are then repeated.

In the non-magnetic one-component non-contact developing apparatus, the developing agent obtains the desired charge characteristics through the frictional charging with a developing support, a developing agent-regulation blade and a developing agent-feeding member. In a non-contact developing apparatus, a support of a latent image and a support of a developing agent are confronted and maintained in some intervals. Thus, development is achieved by only electric power due to the electric potential difference.

Accordingly, if the charge characteristics of a developing agent are lower than a proper range, it is developed on a non-image area thereby to cause image contamination. If the charge characteristics are higher than a proper range, the developing efficiency is decreased thereby decreasing the image concentration.

In Japanese patent publication No. 2000-242043, the metal complex of an azo-based dye and a trimethylethane-based dye were used as a charge control agent, however, they were incomplete in terms of fusing property, etc. due to use of heavy metals. Further, they were detrimental to humans, and were disadvantageous in terms of environment.

### SUMMARY OF THE INVENTION

The present invention provides an electrophotographic developing agent that can maintain stable charges, uniform charge distribution and excellent fusing property, and is not harmful to the environment.

The present invention also provides an electrophotographic image forming apparatus employing the developing agent.

According to an aspect of the present invention, there is provided an electrophotographic developing agent is provided where the developing agent includes toner particles containing a binder resin, a colorant, a charge control agent and a release agent; and an external additive on the surface of the toner particles, wherein the charge control agent is a light metal complex compound, the release agent is a solid fatty acid ester based material, and the amount of the release agent is 1.5 to 4.0% by weight based on total weights of the toner particles.

According to another aspect of the present invention, there is provided an electrophotographic imaging apparatus employing the electrophotographic developing agent.

These and other aspects of the invention will become apparent from the following detailed description of the invention which disclose various embodiments of the invention.

### BRIEF DESCRIPTION OF THE DRAWING

The above and other features and advantages of the present invention will become more apparent by the exemplary embodiments with reference to the attached drawing in which:

FIG. 1 is a schematic view of an embodiment of a non-contact developing type electrophotographic apparatus.

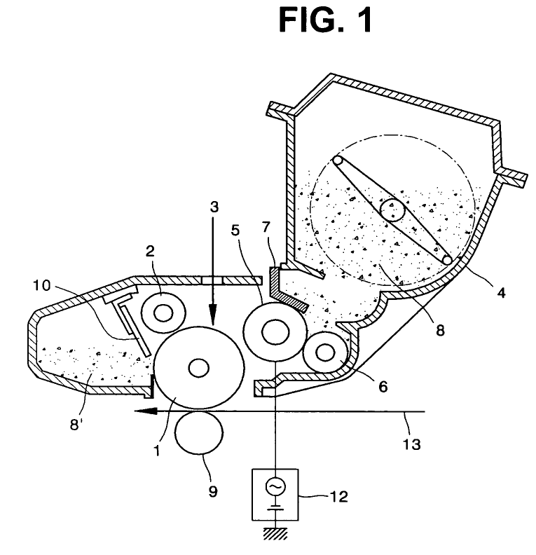

### DETAILED DESCRIPTION OF THE INVENTION

The present invention will now be described more fully hereinafter.

The present invention provides an electrophotographic developing agent comprising toner particles containing a binder resin, a colorant, a charge control agent and a release agent; and an external additive to be added to the surface of the toner particles. The charge control agent is a light metal complex compound. The release agent is a solid fatty acid ester based material. The amount of the release agent is 1.5 to 4.0% by weight based on total weights of the toner particles.

Both of a negatively chargeable charge control agent and a positively chargeable charge control agent can be used as the charge control agent in the present invention. The charge control agent supports a toner on a developing roller by electrostatic force in a stable manner, and thus stable and rapid charging speed can be obtained by the charge control agent.

The term “light metal” herein refers to a metal counterpart to a heavy metal. Heavy metal complexes or chelate compounds such as chromium-containing azo dyes, or salicylic acids containing heavy metal such as chromium or iron were conventionally used in the prior developing agents. A light metal complex compound such as alkali metal, alkaline earth metal, aluminium and zinc, etc. can be used in the present invention.

According to an embodiment of the present invention, the charge control agent can be selected from the group consisting of a salicylic acid compound, such as salicylic acid or an alkyl salicylic acid, containing a metal such as zinc or aluminum, a boron complex of bis diphenyl glycolic acid and a silicate. More particularly, zinc dialkyl salicylic acid or boro bis(1,1-diphenyl-1-oxo-acetyl potassium salt) can be used.

The amount of the charge control agent contained in the toner composition may be generally in the range of 0.5 to 3.0% by weight based on 100% by weight of the toner particles. If the amount of the charge control agent exceeds 3.0% by weight, charging or fusion can become poor. If the amount of the charge control agent is less than 0.5% by weight, the addition effect may be insignificant.

Meanwhile, toner particles according to the present invention comprise a release agent that is a solid fatty acid ester-based material. A release agent can be properly used in order to obtain high quality images by protecting a photoreceptor and preventing deterioration of development characteristics. A release agent according to an embodiment of the present invention may be a highly pure solid fatty acid ester-based material, and be synthesized from long chain fatty acids and various alcohols.

The amount of the release agent is 1.5 to 4.0% by weight based on the total weight of the toner particles. If the amount of the release agent is less than 1.5% by weight, poor fusion may occur and thus the area to be fused may be narrower. If the amount of the release agent exceeds 4.0% by weight, fusion may be offset.

A solid fatty acid ester-based release agent according to the present invention has characteristics such as narrow melting range, heat stability (high degradation temperature), low melting capacity, low yield of subliming gas and high solid hardness.

According to an embodiment of the present invention, the melting point of the release agent may be 72 to 74° C.

The solubility parameter of the release agent may be 8.9 to 9.4. The solubility coefficient (δ) denotes the property value of a liquid to be a measure of mixing between liquids. The thermodynamic properties of a solution depend on the difference of δ values.

The acid value of the release agent may be 0.1 to 0.4 mg KOH/g, and its hydroxyl value may be 1.5 to 3.0 mg KOH/g. The acid value is determined to obtain the amount of free fatty acids in oils and fats, and is expressed as the amount of potassium hydroxide (mg) needed for neutralizing free fatty acids present in 1 g of the oils and fats. The hydroxyl value is used in quantitation of hydroxyl groups, and is expressed as the amount of potassium hydroxide (mg) needed for neutralizing acetic acid generated from acetylation of 1 g of the oils and fats and then their hydrolysis.

The release agents according to the present invention are ester-based waxes synthesized from long chain fatty acids and various alcohols, and may be solid fatty acid ester waxes.

Various known resins can be used as binder resins used in developing agents according to the present invention. For example, styrenic copolymers such as polystyrene, poly-p-chlorostyrene, poly-α-methylstyrene, styrene-chlorostyrene copolymer, styrene-propylene copolymer, styrene-vinyltoluene copolymer, styrene-vinylnaphthalene copolymer, styrene-acrylic acid methyl copolymer, styrene-acrylic acid ethyl copolymer, styrene-acrylic acid propyl copolymer, styrene-acrylic acid butyl copolymer, styrene-acrylic acid octyl copolymer, styrene-methacrylic acid methyl copolymer, styrene-methacrylic acid ethyl copolymer, styrene-methacrylic acid propyl copolymer, styrene-methacrylic acid butyl copolymer, styrene-α-chloromethacrylic acid methyl copolymer, styrene-acrylonitrile copolymer, stryrene-vinylmethylether copolymer, stryrene-vinylethylether copolymer, stryrene-vinylethylketone copolymer, styrene-butadiene copolymer, styrene-acrylonitrile-indene copolymer, styrene-maleic acid copolymer, and styrene-maleic acid ester; polymethylmethacrylate, polyethylmethacrylate, polybutylmethacrylate and copolymers thereof; polyvinyl chloride, polyvinyl acetic acid, polyethylene, polypropylene, polyester, polyurethane, polyamide, epoxy resin, polyvinylbutyral resin, rosin, modified rosin, terpene resin, phenol resin, aliphatic or alicyclic hydrocarbon resin, aromatic petroleum resin, chlorinated paraffin, paraffin wax, etc. can be used alone or in combination. Of these, polyester-based resins are suitable for a color developing agent due to excellent fusing and transparent properties.

A developing agent according to the present invention can comprise a colorant. For a black and white toner, Carbon black or aniline black can be used as such a colorant. With a non-magnetic toner according to the present invention, it is easy to prepare a color toner. Further, a color toner comprises Carbon black for black, and further comprises yellow, magenta and cyan colorant for color.

The yellow colorant can be a condensed nitrogen compound, an isoindolinone compound, an anthraquinone compound, an azo metal complex or an allyl imide compound. Specifically, C.I. PIGMENT YELLOW 12, 13, 14, 17, 62, 74, 83, 93, 94, 95, 109, 110, 111, 128, 129, 147 or 168, etc. can be used.

The magenta colorant can be a condensed nitrogen compound, an anthraquinone compound, a quinacridone compound, a basic dye lake compound, a naphthol compound, a benzimidazole compound, a thioindigo compound or a perylene compound. Specifically, C.I. PIGMENT RED 2, 3, 5, 6, 7, 23, 48:2, 48:3, 48:4, 57:1, 81:1, 144, 146, 166, 169, 177, 184, 185, 202, 206, 220, 221 or 254, etc., can be used.

The cyan colorant can be a copper phthalocyanine compound and its derivative, an anthraquinone compound or a basic dye lake compound. Specifically, C.I. PIGMENT BLUE 1, 7, 15, 15:1, 15:2, 15:3, 15:4, 60, 62 or 66, etc. can be used.

These colorants can be used alone or in a mixture of at least two types of colorants, and can be selected in consideration of color, saturation, brightness, weather proofness, dispersity in toners, etc.

The amounts of the colorants may be sufficient amounts to colorize a toner capable of forming a visible image by development, and, for example, may be 2 to 20 parts by weight based on 100 parts by weight of a binder resin. If the amount is less than 2 parts by weight, the colorizing effect may be insufficient. If the amount exceeds 20 parts by weight, the electrical resistance is decreased, and thus sufficient frictional charges cannot be obtained and thus cause contamination.

Flushing may be performed or a master batch melted and kneaded with a resin in high concentration may be employed in advance so that a colorant may be dispersed uniformly in a resin. For example, a binder resin and a colorant may be mixed as essential components by kneading means such as a 2-roll, a 3-roll, a pressurized kneader or twin-screw extruder. Herein, the colorant is dispersed uniformly and the mixture is melted and kneaded at 80 to 180° C. for 10 minutes to 2 hours. Then, the resulting product is pulverized using a pulverizer such as a jet mill, an attritor or a rotary mill, and thus toner particles having 3 to 15 μm of average particle size are prepared and the powder mobility or charge stability, etc. are enhanced by attaching an external additive.

In general polymerizing and pulverizing toners, a colorant, a charge control agent, and a release agent, etc. are uniformly and internally added into a binder resin in order to enhance chromaticity, charge characteristics and fusing property, etc. Various types of external additives are added in order to impart mobility, charge stability and cleaning property, etc. At least two types of external additives having different average particle size can be used in combination since the external additive on the toner surface is left or embedded when adding an external additive, thereby deteriorating the image.

A developing agent according to the present invention can be also applied to a contact type non-magnetic one-component developing type toner. The developing agent can also be used in an electrophotographic apparatus using a non-contact type non-magnetic one-component toner. Further, it can be applied to both negatively chargeable and positively chargeable toners.

An electrophotographic developing agent according to the present invention comprises toner particles containing a binder resin, a colorant, a charge control agent and a release agent; and an external additive to be added to the surface of the toner particles, wherein the external additive may include a large particle diameter silica component, a small particle diameter silica component, titanium dioxide and polymer beads.

Silica can be used as an inorganic particulate in the present invention, and at least two types of silica having different particle diameters may be added. The two types of silica to be added may include large particle diameter silica having average particle diameter of 20 to 200 nm and small particle diameter silica having average particle diameter of 5 to 20 nm. When using the two types of silica particles having different particle diameters, the large particle diameter silica prevents deterioration of toners by providing durability as a spacer particle and enhances transferability. The small particle diameter silica imparts mainly mobility to toners.

The amounts of the large particle diameter silica particles and the small particle diameter silica particles are each independently 0.1 to 3.0% by weight based on total weight of the toner. When the amounts are less than 0.1% by weight. The desired effects of silica addition cannot be easily obtained. When the amounts exceed 3.0% by weight, the toner exhibits a decrease in fusing property, over-charging and poor cleaning.

When silica having a relatively large specific surface area is only used, considerably good result is obtained in terms of transfer efficiency. However, when many sheets are printed for long term, drum contamination may occur, and thus an inorganic particulate in addition to silica can be used for remarkable improvement. Material that can be used as the inorganic particulate includes titanium oxide, aluminium oxide, zinc oxide, magnesium oxide, cerium oxide, iron oxide, copper oxide or tin oxide, etc. Titanium dioxide may be used.

Titanium dioxide can enhance the mobility of a toner by controlling the average particle diameter with two types of silica having different primary average particle diameters, maintain high transfer efficiency even when printing out many sheets for long term, and enhance environmental stability by preventing drum contamination. Particularly, the charge up of a toner at low temperature and low humidity can be prevented, and the charge down of a toner at high temperature and high humidity can be prevented. The primary average particle diameter of titanium dioxide may be 10 to 500 nm, and may be also 10 to 100 nm. If the average particle diameter exceeds 500 nm, the charge down of a toner at high temperature and high humidity can occur. When the average particle diameter is smaller than 10 nm, poor fusion and charge non-uniformity, etc. can easily occur.

The amount of titanium dioxide can vary by control with the two types of silica particles, and may be 0.1 to 2.0% by weight based on total weight of a toner, and may also be 0.1 to 1.5% by weight. When the amount of hydrophobic titanium oxide is less than 0.1% by weight, an effect of removing drum contamination can be decreased thereby causing image contamination. When its amount exceeds 2.0% by weight, the frictional charges can decrease and thus the desired images cannot be obtained.

The developing agent according to the present invention may further comprise polymer beads in addition to the external additives. Polymer beads are used in order to prevent the occurrence of the image contamination due to the developing member contamination. The polymer beads include melanin-based beads or polymethylmethacrylate (PMMA). The size of the primary average particle of the polymer beads may be 0.1 to 3 μm, and may also be 0.2 to 2 μm. If the size of average particle is smaller than 0.1 μm, the effect of the polymer beads cannot be easily obtained. When the size exceeds 3 μm, the polymer beads can be easily separated and left from the toner. The melanin-based beads and polymethylmethacrylate can be used alone or in combination. The total amount of the polymer beads to be used may be 0.1 to 0.5% by weight based on total weight of a toner. If the amount is less than 0.1% by weight, the effect of polymer beads cannot be easily obtained. If the amount exceeds 0.5% by weight, separation-off and self-aggregation can easily occur.

According to another embodiment of the present invention, an electrophotographic imaging apparatus is provided employing the electrophotographic developing agent comprising toner particles containing a binder resin, a colorant, a charge control agent and a release agent; and an external additive to be added to the surface of the toner particles, wherein the charge control agent is a light metal complex compound, and the release agent is a solid fatty acid ester based material.

The present invention will be described in greater detail with reference to the following examples. The following examples are for illustrative purposes only and are not intended to limit the scope of the invention.

### EXAMPLES

### Example 1

88.5% by weight of polyester having weight-average molecular weight of 100,000, 7.5% by weight of yellow, magenta or cyan master batch (prepared by Mitsubishi Chemical Co.) as a colorant, 1.0% by weight of boro bis(1,1-diphenyl-1-oxo-acetyl potassium salt) [trade name: LR147, prepared by Japan Carlit Co.] as a charge control agent and 3.0% by weight of WEP-3 (prepared by Japan Fats and Oils Co.) as a release agent were premixed using Henschel type mixer.

Then, the mixture was put in a twin-screw extruder, and the melted mixture was extruded at 130° C. and coagulated with cooling. The untreated toner having average particle diameter of 8 μm prior to external addition was obtained by employing a grinding classifier. Then, the toner of the example in the present invention was prepared by externally adding the following external additives to the untreated toner. 2.0% by weight of large particle diameter silica (primary particle diameter of 7˜16 nm, prepared by Nippon Aerosil Co.), 1.2% by weight of small particle diameter silica, 0.3% by weight of titanium dioxide and 0.2% by weight of polymethyl methacrylate were used as the external additives.

### Example 2

A toner was prepared and its surface was subjected to external addition with the same condition as in Example 1, except that 1.0% by weight of zinc dialkyl salicylate compound was used as a charge control agent.

### Comparative Example 1

86.5% by weight of polyester having weight-average molecular weight of 100,000, 7.5% by weight of yellow, magenta or cyan master batch (prepared by Mitsubishi Chemical Co.) as a colorant, 1.0% by weight of boro bis(1,1-diphenyl-1-oxo-acetyl potassium salt) [trade name: LR147, prepared by Japan Carlit Co.] as a charge control agent and 5.0% by weight of WEP-5 (prepared by Japan Fats and Oils Co.) as a release agent were premixed using Henschel type mixer.

Then, the mixture was put in a twin-screw extruder, and the melted mixture was extruded at 130° C. and coagulated with cooling. The untreated toner having average particle diameter of 8 μm prior to external addition was obtained by employing a grinding classifier. Then, the toner of the example in the present invention was prepared by externally adding the following external additives to the untreated toner. 2.0% by weight of large particle diameter silica (primary particle diameter of 7˜16 nm, prepared by Nippon Aerosil Co.), 1.2% by weight of small particle diameter silica, 0.3% by weight of titanium dioxide and 0.2% by weight of polymethyl methacrylate were used as the external additives. A toner of the Comparative Example 1 was prepared by external addition.

### Comparative Example 2

A toner was prepared in the same method as in Comparative Example 1, except that 5.0% by weight of WEP-3 (prepared by Japan Fats and Oils Co.) were used as a release agent.

### Comparative Example 3

A toner was prepared in the same method as in the Comparative Example 1, except that 1.5% by weight of Carnauba wax and 1.5% by weight of hydrocarbon-based wax prepared by Fisher Tropsch method were used as release agents.

### IMAGE EVALUATION TEST

The operation condition of a developing apparatus was as follows:
Surface electric potential (V₀): −600V
Latent image electric potential (V_{L}): −100V
Voltage applied to the developing roller: V_{P-P}=1.8 KV, frequency=2.0 kHz, V_{dc}=−300V, efficiency ratio=35% (spherical wave)
Developing gap: 300 μm
Developing roller:
   Rubber roller (NBR-based elastic rubber roller)
      resistance: 1×10⁵Ω to 5×10⁶Ω
      hardness: 50
   Toner: Charge per mass (q/m)=15 to 25μ C/g (on developing roller after passing developing agent regulating blade)
      Toner weight per area (m/a)=0.3 mg/cm² to 1.0 mg/cm²

### EVALUATION OF IMAGES

Images were evaluated for the toners of Examples 1 and 2, and Comparative Examples 1 to 3 by employing 6/24 ppm grade laser printer (Samsung CLP-510). Initial fusing property was determined with 5% character pattern at ambient temperature and humidity, 7,000 sheets (color, 5,000 sheets) printing test was performed, and the degree of contamination was determined and evaluated per 2,000 sheets (color, 1,500 sheets). The fusing property was determined using papers in the range of 60 g/m² to 90 g/ m² at 160 to 190° C. based on 180° C., and the degree of contamination in images was determined with naked eyes for that by a control blade in long-term printing.

### TEST RESULTS

TABLE 1
Fusing property

| | Property |
|---|---|
| Example 1 | ◯ |
| Example 2 | ◯ |
| Comparative Example 1 | Δ |
| Comparative Example 2 | X |
| Comparative Example 3 | X |

In Table 1, the fusing property was expressed as follows:
◯: Offset, etc. did not substantially occur.
Δ: Offset, etc. occurred to an acceptable level.
X: Offset, etc. occurred to an unacceptable level.

TABLE 2
Image contamination

| | | | | | 7000 |
|---|---|---|---|---|---|
| | | 2000 | 4000 | 6000 | (Color |
| | Initial | (Color 1500) | (Color 3000) | (Color 4500) | 5000) |
| Example 1 | ◯ | ◯ | ◯ | ◯ | ◯ |
| Example 2 | ◯ | ◯ | ◯ | ◯ | Δ |
| Comp. | ◯ | ◯ | Δ | Δ | Δ |
| Example 1 | | | | | |
| Comp. | ◯ | ◯ | Δ | Δ | Δ |
| Example 2 | | | | | |
| Comp. | ◯ | ◯ | Δ | Δ | Δ |
| Example 3 | | | | | |

In Table 2, when image contamination hardly occurred, the result is expressed as ◯, and when a little contamination occurred in identifiable level, the result is expressed as Δ.

The developing agent according to the present invention can distribute stable charges over long term by using light metal complex as a charge control agent and a solid fatty acid ester as a release agent in preparing a toner. Further, according to the developing agent, excellent toner fusing property and developing property can be maintained. Therefore, toner durability can be enhanced due to control of contamination and scattering, and excellent gloss and enhancement of developing efficiency, and thus high quality of images can be obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic developing agent comprising toner particles containing a binder resin, a colorant, a charge control agent and a release agent; and an external additive added to the surface of the toner particles, wherein the charge control agent is a light metal complex compound, the release agent is a solid fatty acid ester based material, and the amount of the release agent is 1.5 to 4.0% by weight based on total weight of the toner particles.

2. The electrophotographic developing agent according to claim 1, wherein the amount of the charge control agent is 0.5 to 3.0% by weight based on total weight of the toner particles.

3. The electrophotographic developing agent according to claim 1, wherein the charge control agent is a compound selected from the group consisting of salicylic acid containing a metal, a boron complex of bis diphenyl glycolic acid, and a silicate, wherein the metal contained in the salicylic acid is zinc or aluminum.

4. The electrophotographic developing agent according to claim 1, wherein the release agent has a melting point of 72° C. to 74° C.

5. The electrophotographic developing agent according to claim 1, wherein the release agent has a solubility parameter of 8.9 to 9.4.

6. The electrophotographic developing agent according to claim 1, wherein the release agent has an acid value of 0.1 to 0.4 mg KOH/g, and a hydroxyl value of 1.5 to 3.0 mg KOH/g.

7. The electrophotographic developing agent according to claim 1, wherein the charge control agent is a compound selected from the group consisting of a zinc dialkyl salicylic acid compound and boro bis(1,1-diphenyl-1-oxo-acetyl potassium salt), and the charge control agent is included in an amount of 0.5 to 3.0% by weight.

8. An electrophotographic image forming apparatus employing an electrophotographic developing agent according to claim 1.

9. An electrophotographic developing agent of claim 1, wherein the charge control agent is an alkali metal, alkaline earth metal, aluminum or zinc metal complex.

10. An electrophotographic developing agent of claim 1, wherein the charge control agent is a metal complex of salicylic acid, an alkyl salicylic acid, bis diphenyl glycolic acid or silicate.

11. An electrophotographic developing agent of claim 1, wherein the release agent is a long chain fatty acid ester.
